(19) United States
(12) Patent Application Publication
(10) Pub. No.: US 2021/0042824 A1
(43) Pub. Date: Feb. 11, 2021

(54) METHODS, SYSTEMS, AND APPARATUSES FOR IMPROVED FRAUD DETECTION AND REDUCTION

(71) Applicant: TOTAL SYSTEM SERVICES, INC,, Columbus, GA (US)

(72) Inventors: Thomas TARLER, Atlanta, GA (US); David ANDRE, Atlanta, GA (US)

(21) Appl. No.: 16/987,142

(22) Filed: Aug. 6, 2020

Related U.S. Application Data
(60) Provisional application No. 62/884,324, filed on Aug. 8, 2019.

(51) Int. Cl. G06Q 40/02; G06K 9/62; G06N 20/00; G06N 5/02

(52) U.S. Cl. CPC G06Q 40/025; G06N 5/027; G06N 20/00; G06K 9/627

(57) ABSTRACT

Methods, systems, and apparatuses for improved fraud detection and reduction are described herein. A system may receive a number of analysis parameters for detecting and reducing fraud. Using the analysis parameters, the system may determine a set of training events for each of a number of selected event types for analysis. Each event type may include one or more attributes. The system may transform each of the attributes. The system may determine a predicted action for each event. The system may include a machine learning module. The predicted action for each event may be provided to the machine learning module to train a machine learning model(s) for fraud detection and prevention.

### CROSS REFERENCE TO RELATED PATENT APPLICATION

This application claims priority to provisional U.S. Application No. 62/884,324, filed on Aug. 8, 2019, the entirety of which is incorporated by reference herein.

### BACKGROUND

Combating fraud is a primary goal for issuer institutions. Most issuer institutions rely on systems that use evolving sets of fraud rules and fraud score determination methods to detect and reduce occurrences of fraud. Implementing new sets of fraud rules and/or methods of determining fraud scores in existing systems is often difficult for issuer institutions. These and other considerations are addressed by the present description.

### SUMMARY

It is to be understood that both the following general description and the following detailed description are exemplary and explanatory only and are not restrictive. Methods, systems, and apparatuses for improved fraud detection and reduction are described herein. These methods, systems, and apparatuses may assist issuer institutions in combating fraud. For example, a system associated with an issuer institution may receive a number of analysis parameters for detecting and reducing fraud. Using the analysis parameters, the system may determine a set of training events for each of a number of selected event types for analysis. Each event type may include one or more attributes, such as numerical variables, categorical variables, an action(s), etc. The system may transform each of the attributes for each event type using an injective transformation, a binary operation, variable elimination, a combination thereof, and/or the like. The system may determine a predicted action for each event based on, for example, the transformed attributes for each event. The system may include a machine learning module. The predicted action for each event may be provided to the machine learning module to train a machine learning model(s) for fraud detection and prevention.

The trained machine learning model(s) may be used to generate an optimized function associated with each selected event type and associated attributes. The system may receive a set of testing events for a selected event type. The system may apply the trained machine learning model(s) to the set of testing events in order to select one or more of the optimized functions. The optimization functions may be selected using the trained machine learning model(s) such that a highest value of a maximization function is achieved. The maximization function may be related to a group of operating parameters and/or efficiencies required by the issuer institution. The system may provide the selected optimized functions to a rule execution engine. The rule execution engine may receive a new event associated with a selected event type(s). The rule execution engine may use the selected optimized functions to determine an action to be taken based on the event. The action may be indicative of whether the event should be processed, rejected, or flagged for further review.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows a block diagram of an example system;

FIG. 2 shows a block diagram of an example system module;

FIG. 3 shows an example process flowchart;

FIG. 4 shows an example process flowchart;

FIGS. 5A and 5B show an example line graphs;

FIG. 6 shows a flowchart of an example method;

FIG. 7 shows a flowchart of an example method; and

FIG. 8 shows a block diagram of an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

As discussed herein, combating fraud is a primary goal for issuer institutions, and most issuer institutions rely on systems that use evolving sets of fraud rules and fraud score determination methods to detect and reduce occurrences of fraud. Implementing new sets of fraud rules and/or methods of determining fraud scores in existing systems is often difficult for issuer institutions, as issuer institutions must comply with complex regulations and other operating parameters. Moreover, it is often difficult for issuer institutions to refine, optimize, and ensure adequate performance of their current systems, since each fraud rule may target a specific set of attributes, and the process of combining fraud rules is painstaking and time-consuming. Described herein are methods, systems, and apparatuses for improved fraud detection and reduction that allow issuer institutions to more efficiently implement a comprehensive system.

The present methods, systems, and apparatuses may employ historical performance data for various fraud scores, which may have some informational value with respect to prior events (e.g., payment card transactions). The historical performance data may be used in order to suggest robust logical fraud rules using similar fraud scores and event attributes to make a decision on an action related to the event, as discussed further herein.

A fraud score as an input value may indicate on a scale a likelihood of some attribute of an event being true. An attribute of the event may indicate categorical knowledge about the type of the event. The present methods, systems, and apparatuses may algorithmically induce a performative value of a fraud score in prior events based on those attributes. New rule sets may then be created in order to use those fraud scores and attributes in similar events in the future.

A rule takes the attributes and fraud scores of an event and assigns an action. The present methods, systems, and apparatuses may automatically generate a rule that is easily deployable and is optimized to have better performance than a score and rule system altogether. In this way, an entire rule system may be optimized. Further, this may allow an issuer to create rules that are optimized to their specific operating model, such as prioritizing fraud recovery efforts over stopping fraud altogether. This may enable tighter operation management for the issuer.

As discussed further herein, the present methods, systems, and apparatuses may assist issuer institutions in combating fraud. For example, a system associated with an issuer institution may receive a number of analysis parameters for detecting and reducing fraud. Using the analysis parameters, the system may determine a set of training events for each of a number of selected event types for analysis. Each event type may include one or more attributes, such as numerical variables, categorical variables, an action(s), etc. The system may transform each of the attributes for each event type using an injective transformation, a binary operation, variable elimination, a combination thereof, and/or the like. The system may determine a predicted action for each event based on, for example, the transformed attributes for each event. The system may include a machine learning module. The predicted action for each event may be provided to the machine learning module to train a machine learning model(s) for fraud detection and prevention.

The trained machine learning model(s) may be used to generate an optimized function associated with each selected event type and associated attributes. The system may receive a set of testing events for a selected event type. The system may apply the trained machine learning model(s) to the set of testing events in order to select one or more of the optimized functions. The optimization functions may be selected using the trained machine learning model(s) such that a highest value of a maximization function is achieved. The maximization function may be related to a group of operating parameters and/or efficiencies required by the issuer institution. The system may provide the selected optimized functions to a rule execution engine. The rule execution engine may receive a new event associated with a selected event type(s). The rule execution engine may use the selected optimized functions to determine an action to be taken based on the event. The action may be indicative of whether the event should be processed, rejected, or a security action should be taken (e.g., the event may be flagged for further review).

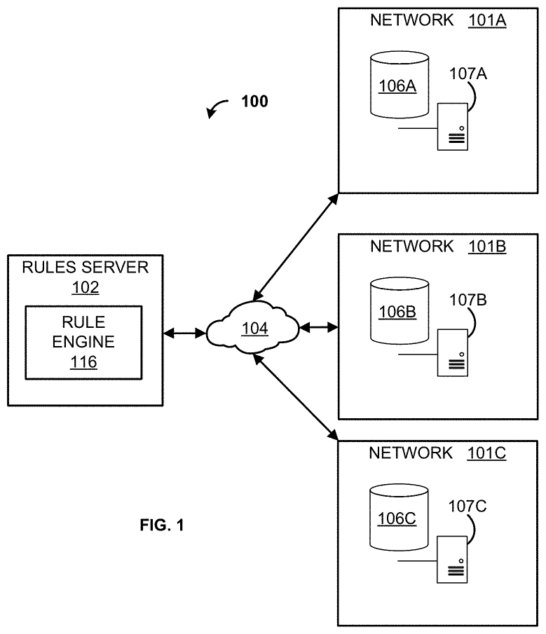

Turning now to FIG. 1, a block diagram of an example system 100 for improved fraud detection and reduction is shown. The system 100 may include a rules server 102 and a plurality of networks 101A, 101B, 101C each in communication with the rules server 102 via a network 104. The rules server 102 may include a rule engine 116. Each of the plurality of networks 101A, 101B, 101C may include at least one database 106A, 106B, 106C (e.g., a payment system database, etc.) and at least one server 107A, 107B, 107C (e.g., a payment system server, etc.).

The rule engine 116 may be used to manage the plurality of networks 101A, 101B, 101C and to optimize fraud detection and reduction for at least one of the networks 101A, 101B, 101C. The rule engine 116 may assist a network operator (e.g., a software system) of the at least one network 101A, 101B, 101C with creation, selection, and execution of one or more optimized functions (e.g., fraud rule(s)) for fraud detection and reduction. The rule engine 116 may collect/aggregate historical event data related to each of the plurality of networks 101A, 101B, 101C for a period of time, such as a day or a week. The historical event data may include a plurality of events (e.g., payment card transactions) processed by each of the servers 107A, 107B, 107C. As discussed further herein, the rule engine 116 may use a trained machine learning model (hereinafter, a “trained model”) to determine whether one or more optimized functions would improve overall fraud detection and reduction for the at least one network 101A, 101B, 101C. For example, the rule engine 116 may use historical event data (e.g., payment card transaction data) associated with the plurality of networks 101A, 101B, 101C to train the model, and the trained model may be used to determine whether one or more optimized functions (e.g., fraud rule(s)) would benefit the at least one network 101A, 101B, 101C.

When the rule engine 116 determines that one or more optimized functions are recommended, a rule execution module 210 may provide the at least one network 101A, 101B, 101C with the one or more optimized functions to implement via a recommendation. The recommendation may be provided to the at least one server 107A, 107B, 107C. The recommendation may indicate one or more event types for each of the one or more optimized functions. An event type may be a type of payment card transaction. Each event type may include one or more attributes, such as numerical variables, categorical variables, an action(s), and/or the like. A numerical variable for an event may include, for example, a transaction amount; a number of items in a transaction; a distance metric between two geographical identifiers (e.g. distance between a purchase and account zip-codes); a frequency and/or quantity of fraudulent events associated with a given payment card; a payment card expiration date; a distance metric with respect to significant dates on a payment card account; a combination thereof, and/or the like. A categorical variable for an event may include, for example, a merchant type (e.g., Merchant Category Code (MCC), merchant category, etc.); a payment card type (e.g., debit, credit, charge, retail store account, etc.); a payment card attribute (e.g., card present, card not present, online, in-store, etc.); an item type (e.g., Stock Keeping Unit (SKU) code, item category, etc.); a combination thereof, and/or the like. An action for an event may include, for example, an indication or recommendation that the event should be processed (e.g., payment should be authorized); an indication or recommendation that the event should be rejected (e.g., payment should not be authorized); an indication or recommendation that the event should be flagged for further review (e.g., to allow a purchaser and/or merchant to be contacted for security purposes); an action that changes the status of an account or another entity based on a sequence of events; a combination thereof, and/or the like.

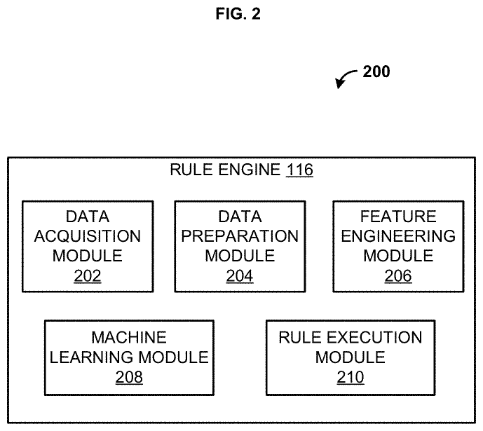

FIG. 2 shows an expanded block diagram of the rule engine 116 of FIG. 1. The rule engine 116 may be used to manage the plurality of networks 101A, 101B, 101C and to optimize fraud detection and reduction for the at least one network 101A, 101B, 101C. While the following description of the rule engine 116 may describe only one server for ease of explanation, it is to be understood that the functionality of the rule engine 116 and its implementation of the methods described herein may apply to a plurality of servers in communication with a network, such as each of the servers 107A, 107B, 107C.

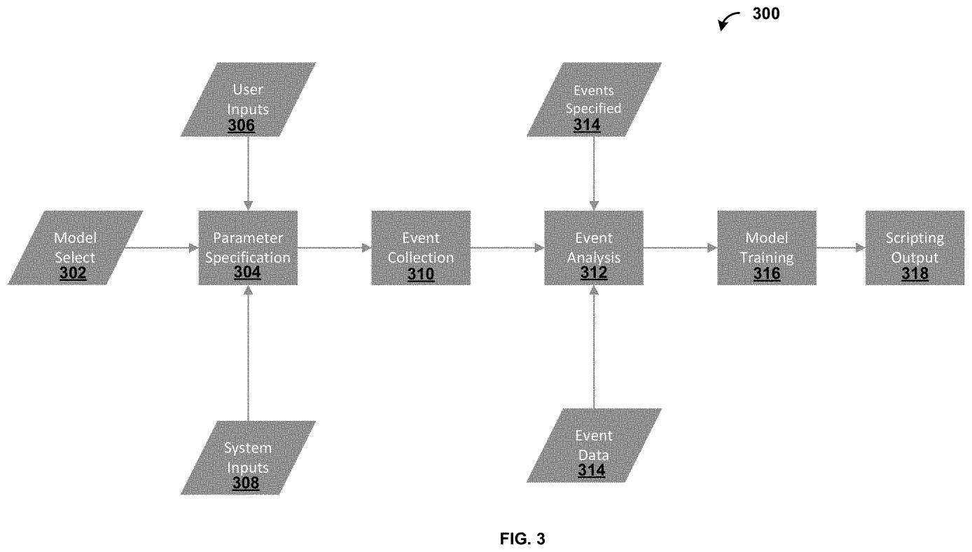

Functionality of the rule engine 116 will be described in combination with FIG. 3, which shows an example rule generation process 300. The rule engine 116 may implement the rule generation process 300 when determining the one or more optimized functions. At step 302, a data acquisition module 202 of the rule engine 116 may receive a model selection (e.g., by a user at a user interface in communication with the rule engine 116). The model may be indicative of a desired result to be achieved using the eventually determined one or more optimized functions. For example, the model may indicate a plurality of cost and revenue components. A cost may be unit operational costs such as labor costs per event and/or action (e.g. a call-center worker contacting a defrauded account holder); increases in cash reserves due to higher anticipated fraud; volume or per-item costs as a result of an action; indirect costs associated with decreased customer lifetime value due to an incorrect action; a combination thereof, and/or the like. A revenue component may be interest and/or interchange fees directly generated by a cardholder transaction; per-item revenues as a result of cardholder and/or merchant revenues as a result of a value-add service, as well as indirect revenue associated with an increase to cardholder increase in spend or utilization as a result of a positive action, a combination thereof, and/or the like. Each revenue and cost component may be weighted differently depending on a given business strategy or policy, for example prioritizing positive customer experiences over a potential gross fraud loss.

At step 304, the data acquisition module 202 may receive parameter specifications. The parameter specifications may include user inputs provided at step 306 and/or system inputs provided at step 308. The user inputs may include one or more event types to be used as training data, such as a one or more types of payment card transactions (e.g., online, in-store, debit, credit, PIN, no-PIN, electronic wallet, etc.). The user inputs may include one or more fraud scores and/or fraud rules (e.g., algorithms used to predict whether a given event is likely fraudulent). The user inputs may include an optimization metric for the one or more optimized functions. The optimization metric may include, for example, a level of accuracy (e.g., a number or percentage of true fraudulent transactions classified), a nominal value (e.g., a card not present transaction), a false positive rate (e.g., a number of legitimate events that are incorrectly classified as fraudulent), and/or a total operational cost for deployment of the system (e.g., an amount of resources and/or money). The user inputs may include a risk tolerance threshold, such as a percentage of non-recoverable fraudulent transactions or a monetary maximum for gross fraud losses.

The system inputs provided at step 308 may relate to the rule engine's 116 overall performance. For example, the system inputs may include an option for the rule engine 116 to consider performance levels of existing optimized functions (e.g., fraud rules) and a threshold to indicate whether a new rule (e.g., an optimized function) may be needed. The threshold may be based on the user inputs, such as the one or more fraud scores and/or fraud rules, the optimization metric, and/or the risk tolerance threshold. The system inputs may also include an option for determining one or more abnormal events. The one or more abnormal events may be one or more historical events that were not determined to be fraudulent based on existing rules but were actually fraudulent (e.g., the existing rules failed to detect the abnormal events as fraudulent). The rule engine 116 may be triggered to determine a new rule (e.g., a new optimization function) when a threshold quantity of abnormal events are detected within the training data.

At step 310, the data acquisition module 202 may collect historical event data based on the one or more event types specified at step 306. Optionally, the data acquisition module 202 may enrich historical events that are collected/aggregated with other external data from other sources (e.g. cardholder credit file data from a credit bureau). Additionally, the data acquisition module 202 may adjust the user inputs and/or the system inputs provided at step 304. For example, the optimization metric associated with the user inputs may include a level of accuracy, and the data acquisition module 202 may adjust the level of accuracy upward or downward. Any of the user inputs may be adjusted by the data acquisition module 202. As another example, the data acquisition module 202 may adjust the quantity of the one or more abnormal events that are required to trigger the rule engine 116 to determine a new rule (e.g., a new optimization function) when the threshold quantity of abnormal events are detected within the training data. Any of the system inputs may be adjusted by the data acquisition module 202. The data acquisition module 202 may be configured to collect/aggregate the historical event data from one or more of the plurality of networks 101A, 101B, 101C.

At step 312, the collected/aggregated historical event data may analyzed by the rule engine 116. For example, the collected/aggregated historical event data may be used by the rule engine 116 to determine the training data. The training set may be further partitioned by a data preparation module 204 of the rule engine 116. At least one portion may be partitioned with respect to time for an “event hold out,” where validation is performed on the most recent events in the dataset where the data is still transformed in the feature engineering module 206 of the rule engine 116 but is withheld from the machine learning module 208 of the rule engine 116 and is instead directly passed to the rule execution module 210. The remaining partition may or may not be partitioned randomly into arbitrary proportions where each proportion is passed into the machine learning module 208 in a piecemeal fashion. The data preparation module 204 may determine a set of training events for the historical event data for each of a number of selected event types for analysis.

The collected/aggregated historical event data may require cleaning/preparation in order to make the historical event data more useful for the rule engine 116. The data preparation module 204 may be configured for initial cleaning of the historical event data and for generating intermediate data staging and temporary tables in a database of the data preparation module 204. For example, the data preparation module 204 may divide the historical event data into multiple subsets based on event type. The data preparation module 204 may store each subset in a different table in the database.

The data preparation module 204 may standardize the historical event data. For example, one or more of the subsets of the historical event data may include event data in a first format or structure while one or more other subsets of the historical event data may include event data in another format or structure. The data preparation module 204 may standardize the historical event data by converting all event data of all subsets of the historical event data into a common format/structure. Each event may include one or more attributes, such as numerical variables, categorical variables, an action(s), etc.

Also at step 312, a feature engineering module 206 of the rule engine 116 may transform all numerical variables. For example, the feature engineering module 206 may, for all numerical variables, apply one or more unary injective transformations as follows: ∀(ƒ|ƒ: [symbol] IR → [symbol] ), v′=(v); where ∀ is the standard mathematical term to represent “for all”, ∃ is the standard mathematical symbol for “there exists”, ƒ is a function that maps the real number line ( [symbol] ) or a subset thereof (all floating point values from negative infinity to positive infinity) to another subset of values in the real number line (e.g. if f is the log transformation, and v is a value, then v′=ƒ(v)=log(v). As another example, the data preparation module 204 may apply one or more binary operations in a real functions space to all permutations of the numerical variables as follows: ∀(ƒ|ƒ: [symbol] × [symbol] → [symbol] ), u×v=ƒ(u,v),u×v×w=ƒ(ƒ(u, v), ƒ(w)); in these instances the × implies a pairing of two or more numerical values with these rules being consistent for any number of operations (e.g. if ƒ(a, b)=a+b (where a,b are numbers) then it follows that ƒ(a, ƒ(b, c))=a+(b+c)=(a+b)+c. and then the result is may be another number or value. Applying the one or more binary operations may include applying a result of a binary operation to a binary operation with a third variable. As a further example, the feature engineering module 206 may apply one or more binary operations in the real functions space to all permutations of the groupings of observations across a numerical row as follows: ∀(ƒ|ƒ: [symbol] × [symbol] → [symbol] ), ƒ_{i,j∈G}(vᵢ, v_{i≠j}) where in this case I and j are indices of all the possible functions that can be applied (denoted as a member of (∈)) and v are all the possible values these functions can be applied to and again are indexed. In an even further example, the feature engineering module 206 may remove any or all numerical variables that perfectly correlate with another variable, the response variable, or have a variance of zero.

The feature engineering module 206 may map all categorical variables to an arbitrary metric in the real numbers space as follows: ∀G, (M:i ∈ G→ [symbol] ), such that ∃d, d(M(i), M(j))>0, d(M(i), M(j))=0↔M(i)=M(J), d(M(i), M(k)≤d(M(i), M(j))+d(M(j), M(k)). These categorical variables represent standard properties associated with a metric space. For example, these properties may include a distance between two different objects that may always be more than zero. The distance may only be zero if and only if you are calculating the distance between two identical elements. If calculating the distance between three elements, then the straight-line distance between the two elements is always less than or equal than the distance where a third element is visited before the last one. In these instance, d is the distance metric that satisfies these properties, and M is an associated space for the metric. Examples of mapping the arbitrary metric include, but are not limited to, using a Bayesian inference for a probability metric, using an Eigen space composed of numerical variables to transform the categorical variables to eigenvectors, mapping each category to a separate variable with a true/false response rate, a combination thereof, and/or the like.

The feature engineering module 206 may determine one or more feature calculations based on the historical event data. For example, the feature engineering module 206 may determine a feature calculation based on a numerical variable, a categorical variable, etc. A feature calculation may include one or more derived values associated with the numerical variable, the categorical variable, etc. For example, a numerical value may include a purchase amount for an event and a given payment card, and a derived value may be an average purchase amount for all other events associated with the payment card. As another example, a derived value may be an indication of how a purchase amount for an event deviates from the average purchase amount for all other events associated with the payment card (e.g., a standard deviation).

The feature engineering module 206 may be configured to prepare the historical event data for input into a machine learning module 208 of the rule engine 116 as a training dataset. For example, the feature engineering module 206 may generate a data point for each event within the historical event data. A given data point may be referred to as a “vector” of historical event data that represents all relevant variables for the given event. The feature engineering module 206 may clean the historical event data by removing duplicate records. The feature engineering module 206 may also eliminate any feature calculations that are present within the historical event data less than a threshold amount of times. For example, a feature calculation having 10 or fewer occurrences within the historical event data may not contribute significantly towards improved fraud detection and reduction.

The feature engineering module 206 may generate new independent variables/features or modify existing features that can improve a determination of a target variable (e.g., whether a given event is fraudulent). The feature engineering module 206 may eliminate feature calculations that do not have significant effect on the target variable. That is, the feature engineering module 206 may eliminate feature calculations that do not have significant effect when determining whether a given event is fraudulent. For example, the historical event data may be analyzed according to additional feature selection techniques to determine one or more independent variables/features that have a significant effect when determining whether a given event is fraudulent. Any suitable computational technique may be used to identify the one or more independent variables/features using any feature selection technique such as filter, wrapper, and/or embedded methods. For example, the one or more independent variables/features may be selected according to a filter method, such as Pearson's correlation, linear discriminant analysis, analysis of variance (ANOVA), chi-square, combinations thereof, and the like. As another example, the one or more independent variables/features may be selected according to a wrapper method configured to use a subset of features and train a machine learning model using the subset of features. Based on inferences that may be drawn from a previous model, features may be added and/or deleted from the subset. Wrapper methods include, for example, forward feature selection, backward feature elimination, recursive feature elimination, combinations thereof, and the like. As a further example, the one or more independent variables/features may be selected according to an embedded method that may combine the qualities of the filter and wrapper methods. Embedded methods include, for example, Least Absolute Shrinkage and Selection Operator (LASSO) and ridge regression which implement penalization functions to reduce overfitting.

As discussed herein, the feature engineering module 206 may be configured to prepare the historical event data for input into a machine learning module 208 of the rule engine 116 as a training dataset. At step 316, the feature engineering module 206 may provide the training dataset to the machine learning module 208. The machine learning module 208 may use an array of modeling methods as described herein to assign an optimal action based on the historical event data. The action may be indicative of whether a given event should be processed, rejected, or a security action should be taken (e.g., the event may be flagged for further review). Event attributes, such as the numerical variable and/or categorical variables discussed herein, may be converted by the machine learning module 208 into an arbitrary metric that corresponds with an optimization and/or business value. The optimization and/or business value may be based on the user inputs and/or the system inputs provided at step 304. The machine learning module 208 may then refine these optimal actions by optimizing against the model selected/determined at step 302 to ensure performance of a determine optimization rule.

For example, the machine learning module 208 may generate an arbitrary function, D, such that D:E→A, where E is an event with associated categorical and numerical variables defined above and A is an action set defining all possible actions for the rule engine 116 to take on the event. The machine learning module 208 may generate initiate an arbitrary function that may be applied to the training data and then assign an action to one or more of historical events of the training data. Based on a difference between the actual action (e.g., as indicated by the training data) and the determined action set, the arbitrary function may be modified to better match the two. The machine learning module 208 may also modify the arbitrary function to prevent overfitting, bias, and other systemic errors as described herein. Once the arbitrary function best matches the actual action with respect to the intended optimization, the arbitrary function is considered complete.

The machine learning module 208 may be configured to utilize various machine learning techniques to analyze the training data. The machine learning module 208 may take empirical data as an input and recognize patterns within the data. As an example, the empirical data may be historical event data for a network. The historical event data may include a plurality of variable calculations determined by the feature engineering module 206. For example, the variable calculations may be aggregated measures or derived values of a numerical or categorical variable, or a combination thereof. Each variable calculation may have a corresponding coefficient to indicate a relative weight of importance of the variable calculation with respect to its impact on rule performance. The machine learning module 208 may determine whether one or more variable calculations (e.g., as indicated by the training data) meet or exceed a prediction threshold (e.g., a prediction score). For example, if the one or more variable calculations results in a prediction score of 70% that a given event in the training data is fraudulent, then the prediction threshold may be met (e.g., a prediction score above 70% may therefore exceed the threshold). Other values for the prediction threshold may be used.

As discussed herein, the machine learning module 208 may be configured to train a classifier of a machine learning model(s) that may be used to classify whether a numerical or categorical variable, or a combination thereof, is indicative of an event being fraudulent. The machine learning module 208 may use the training dataset to train the classifier. When training the classifier, the machine learning module 208 may evaluate several machine learning algorithms using various statistical techniques such as, for example, accuracy, precision, recall, Fl-score, confusion matrix, receiver operating characteristic (“ROC”) curve, and/or the like. The machine learning module 208 may also use a Random Forest algorithm, a Gradient Boosting algorithm, an Adaptive Boosting algorithm, K-Nearest Neighbors algorithm, a Naïve Bayes algorithm, a Logistic Regressor Classifier, a Support Vector machine, a combination thereof and/or the like when training the classifier. Gradient Boosting may add predictors to an ensemble classifier (e.g., a combination of two or more machine learning models/classifiers) in sequence to correct each preceding prediction (e.g., by determining residual errors). The K-Nearest Neighbors algorithm may receive each data point within the historical event data and compare each to the “k” closest data points. The AdaBoost Classifier may attempt to correct a preceding classifier's predictions by adjusting associated weights at each iteration. The Support Vector Machine may plot data points within the historical event data in n-dimensional space and identify a best hyperplane that separates the variable calculations indicated by the historical event data into two groups (e.g., meeting the prediction threshold vs. not meeting the threshold). Logistic Regression may be used to identify an equation that may estimate a probability of a given event being fraudulent. Gaussian Naïve Bayes may be used to determine a boundary between two groups of variable calculations based on Bayesian conditional probability theorem. A Random Forest Classifier may comprise a collection of decision trees that are generated randomly using random data sampling and random branch splitting (e.g., in every tree in the random forest), and a voting mechanism and/or averaging of outputs from each of the trees may be used to determine whether a variable calculations meets or does not meet the prediction threshold.

The machine learning module 208 may select one or more machine learning models to generate an ensemble classifier (e.g., an ensemble of one or more classifiers). Selection of the one or more machine learning models may be based on each respective models' F-1 score, precision, recall, accuracy, and/or confusion metrics (e.g., minimal false positives/negatives). For example, the ensemble classifier may use Random Forest, Gradient Boosting Machine, Adaptive Boosting, Logistic Regression, and Naïve Bayes models. The machine learning module 208 may use a logistic regression algorithm as a meta-classifier. The meta-classifier may use respective predictions of each model of the ensemble classifier as its features to make a separate determination of whether a variable calculation meets or does not meet the prediction threshold.

The machine learning module 208 may train the ensemble classifier based on the training dataset. For example, the machine learning module 208 may train the ensemble classifier to predict results for each of the multiple combinations of variables within the training dataset. The predicted results may include soft predictions, such as one or more predicted results, and a corresponding likelihood of each being correct. For example, a soft prediction may include a value between 0 and 1 that indicates a likelihood of an event being fraudulent, with a value of 1 being a prediction with 100% accuracy, and a value of 0.5 corresponding to a 50% likelihood. The machine learning module 208 may make the predictions based on applying the features engineered by the feature engineering module 206 to each of the multiple combinations of variables within the training dataset.

The meta-classifier may be trained using the predicted results from the ensemble classifier along with the corresponding one or more variable calculations within the training dataset. For example, the meta-classifier may be provided with each set of the variables and the corresponding prediction from the ensemble classifier. The meta-classifier may be trained using the prediction from each classifier that is part of the ensemble classifier along with the corresponding one or more variable calculations.

The meta-classifier may be trained to output improved predictions that are based on the resulting predictions of each classifier of the ensemble classifier based on the same variable calculations. The meta-classifier may then receive a further testing dataset that includes further historical event data and variables, and the meta-classifier may predict whether a given event within the further training dataset is likely fraudulent. The prediction by the meta-classifier that is based on the ensemble classifier may include one or more predicted results along with a likelihood of accuracy of each prediction.

At step 318, the machine learning module 208 may generate one or more optimized functions (e.g., fraud rule(s)) for fraud detection and reduction) based on the analysis of the training dataset described above. The one or more optimized functions may be output by the machine learning module 208 as a script, such as a set of logical trees or a model markup language, for deployment into a real time high throughput network, such as the at least one network 101A, 101B, 101C described above. As described above, each variable calculation may have a corresponding coefficient to indicate a relative weight of importance of the variable calculation with respect to its impact on predicting whether an event is likely fraudulent. Each corresponding coefficient of each variable calculation may be optimized by the machine learning module 208 for minimizing a cost function associated with the model selected at step 302 given the attributes of the training dataset. For instance, in the context of classification, the model may be visualized as a straight line that separates the variable calculations into two classes (e.g., labels). The cost function may consider a number of misclassified points of variable calculations. The misclassified points may be a plurality of data points that the machine learning module 208 incorrectly classifies as not meeting or exceeding the prediction threshold. A learning process may be employed by the machine learning module 208 to adjust coefficient values for the variable calculations such that the number of misclassified points is minimal. After this optimization phase (e.g., learning phase), the one or more optimized functions may be determined and used to predict whether a new event (e.g., not part of the training dataset) contains variables/attributes that are indicative of the event being fraudulent.

The machine learning module 208 may employ one or more supervised, unsupervised, or semi-supervised machine learning models. Generally, supervised learning entails the use of a training set of data as discussed herein that may be used to train a machine learning model to apply labels to the input data. Unsupervised techniques, on the other hand, do not require a training set of labels. While a supervised machine learning model may determine whether previously seen patterns in a training dataset have been correctly labeled in a testing dataset, an unsupervised model may instead determine whether there are sudden changes in values of the plurality of data points. Semi-supervised machine learning models take a middle ground approach that uses a greatly reduced set of labeled training data as known in the art.

The machine learning module 208 may employ one or more machine learning algorithms such as, but not limited to, a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic or other regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The machine learning module 208 may include any number of machine learning models to perform the techniques herein, such as for cognitive analytics, predictive analysis, and/or trending analytics as known in the art.

The machine learning module 208 may be configured to use the trained machine learning model to select one or more of the generated optimized functions to be provided to a rules execution module 210 for deployment in a real time high throughput network, such as the at least one network 101A, 101B, 101C. The machine learning module 208 may receive a testing dataset based on the user inputs and the system inputs provided at step 302 and/or the model selected at 302. The testing dataset may include a plurality of events. Each event may include one or more numerical variables, one or more categorical variables, and an action. The machine learning module 208 may apply the trained machine learning model to the testing dataset to select one or more of the optimized functions that result in a highest value of at least one maximization function. The trained machine learning model may include the generated optimized functions.

The machine learning module 208 may apply the trained machine learning model to the testing dataset using an arbitrary ring structure consisting of the optimized functions as members and outputs. The machine learning module 208 may apply one or more binary operations to the ring structure. The machine learning module 208 may select one or more of the optimized functions that result in a highest value of the at least one maximization function. The at least one maximization function may include a numerical value. For example, the numerical value may be based on one or more optimization metrics selected at step 306 and/or step 308. The at least one maximization function may be an arbitrary scalar profit function. The arbitrary scalar profit functions may defined as having (1) a global profit component that may calculate a numerical value for a particular sequencing of rule executions against the model selected at step 302 (e.g., a total cost of fraudulent activity); and (2) and individual profit component that may calculate a numerical value for each individual rule based on the optimization metrics selected at step 306 and/or step 308.

For each permutation of rule ordering employed by the ring structure, the machine learning module 208 may calculate a global profit and select the permutation resulting in the greatest profit. Rules with greater individual profit will then be prioritized for ring combination. In this case, an arbitrary number of the binary operations defined by the ring structure may be applied to the functions to generate a new set of functions. The number of binary operations that a rule may be engaged in may be dictated by the individual profit component in order to promulgate better rules, with the worst performing rules dropped from the system altogether. The selected one or more of the optimized functions may be selected based on a maximization of the numerical value.

The selected one or more of the optimized functions may be provided by the machine learning module 208 to the rules execution module 210 for deployment. The rules execution module 210 may receive a new event comprising an event type, one or more numerical variables, and one or more categorical variables. The rules execution module 210 may use the selected one or more of the optimized functions to determine an action based on the event. The action may be indicative of whether the event should be processed or rejected.

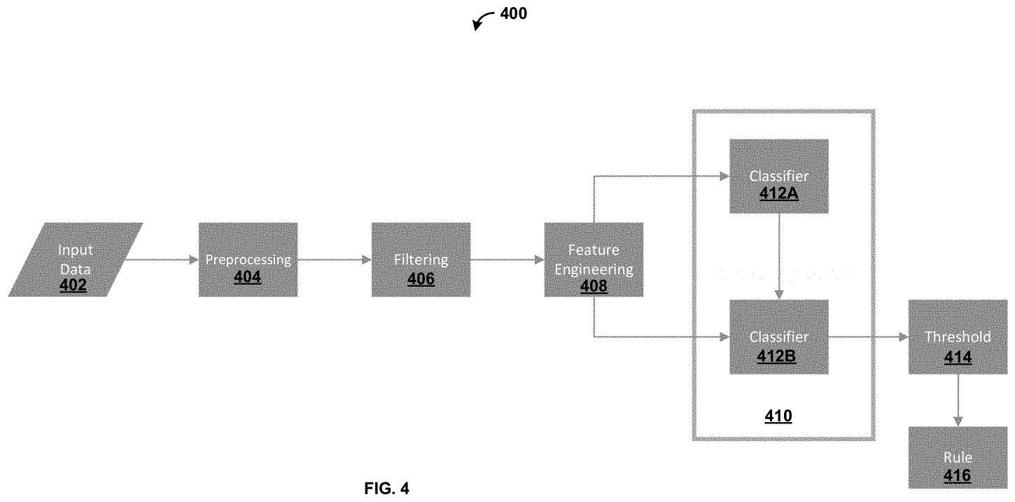

Turning now to FIG. 4, an example process 400 for generating an optimized rule is shown. The process 400 may use the process 300 when generating an optimized rule. At step 402, the data acquisition module 202 may receive input data, such as the training dataset, the user inputs provided at step 306, the system inputs provided at step 308, and/or the model selected at step 302. At step 402, the data preparation module 204 may preprocess the training dataset as described above. At step 406, the data preparation module 204 may filter features associated with the training dataset as described above. At step 408, the feature engineering module 206 may perform feature engineering on the training dataset as described above. The feature engineering module 206 may provide the training dataset—after being processed by the feature engineering module 206—to a machine learning model 410. The machine learning model 410 may include a first classifier 412A and/or a second classifier 412B. For example, the feature engineering module 206 may provide the categorical variables associated with the training dataset to the first classifier 412A. As another example, the feature engineering module 206 may provide the numerical variables associated with the training dataset to the second classifier 412B. The first classifier 412A may be a naïve Bayes classifier, while the second classifier 412B may be a Gradient Boosted Tree classifier.

The first classifier 412A and/or the second classifier 412B may process the data received to determine whether any of the numerical variables and/or categorical variables are good predictors for fraudulent activity. For example, to machine learning model 410 may indicate a likelihood that a categorical variable, such as a Merchant Category Code, is indicative of fraudulent activity when certain other categorical variables and/or numerical variables are present. This likelihood (e.g., 75%) may be compared to a threshold at 414, and an optimized function (e.g., a fraud rule) may be generated when the likelihood satisfies the threshold (e.g., 70% or more). The optimized function may include the categorical variable (e.g., the Merchant Category Code) and the certain other categorical variables and/or numerical variables are present (e.g., correlated with fraudulent activity). The optimized function may be provided to the rule execution engine 210.

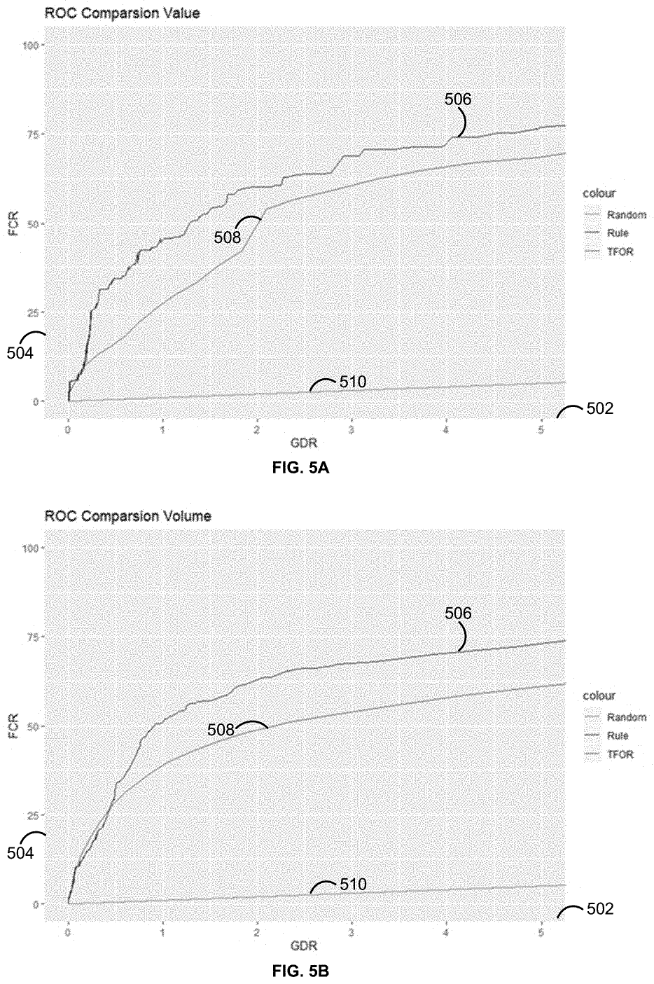

Performance of the machine learning model 410 may be evaluated in a number of ways based on a number of true positives, false positives, true negatives, and/or false negatives classifications of the plurality of data points indicated by the machine learning model 410. For example, the false positives of the machine learning model 410 may refer to a number of times the model incorrectly classified one or more variable calculations as not meeting or exceeding the prediction threshold. Conversely, the false negatives of the machine learning model 410 may refer to a number of times the machine learning model classified one or more variable calculations as meeting or exceeding the prediction threshold when, in fact, the one or more variable calculations did not meet or exceed the prediction threshold. True negatives and true positives may refer to a number of times the machine learning model 410 correctly classified the one or more performance metrics with respect to meeting, or not meeting, the prediction threshold, respectively. Performance of the machine learning model is depicted in FIGS. 5A and 5B as ROC comparison values. As seen in FIGS. 5A and 5B, the optimized function 506 generated by the machine learning model 410 outperforms both certain existing functions 508 (e.g., one or more existing fraud rules created in a different manner) as well as randomly applied functions 510

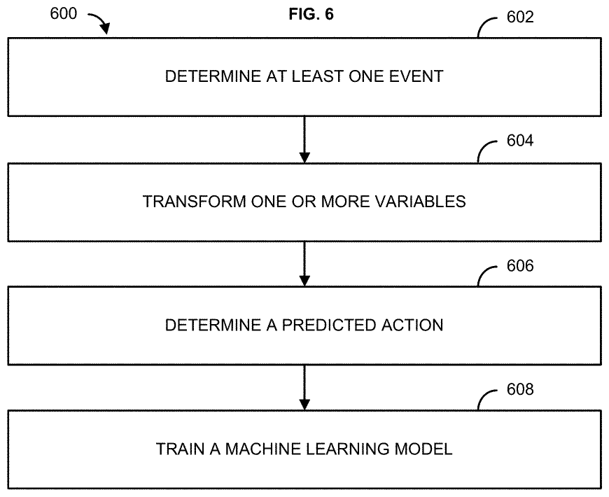

Turning now to FIG. 6, an example method 600 for improved fraud detection and reduction is shown. The method 600 may be performed by the rule engine 116 of FIG. 1. One or more steps of the method 600 may incorporate one or more steps of the processes 300 and/or 400 to train a machine learning model. For example, a system associated with an issuer institution may receive a number of analysis parameters for detecting and reducing fraud. At step 602, using the analysis parameters, the system may determine a set of training events for each of a number of selected event types for analysis. Each event type may include one or more attributes, such as numerical variables, categorical variables, an action(s), etc. At step 604, system may transform each of the attributes for each event type. The attributes may be transformed using one or more of an injective transformation, a binary operation, variable elimination, a combination thereof, and/or the like. The one or more categorical variables for each of the training events may be mapped to an arbitrary metric using one or more of a Bayesian inference model or eigenvector transformation. At step 606, the system may determine a predicted action for each event based on, for example, the transformed attributes for each event. Determining the predicted action may include generating an arbitrary function for each of the training events based on the transformed one or more numerical variables and the mapped one or more categorical variables. Based on the arbitrary function, a predicted action may be assigned for an event. The system may include a machine learning module. At step 608, the predicted action for each event may be provided to the machine learning module to train a machine learning model(s) for fraud detection and prevention. Training the machine learning model may include determining a difference between the determined action and the predicted action for an event. Further, training the machine learning model may include determining, based on the difference between the determined action and the predicted action for the event, a weight for each of the transformed one or more numerical variables and the transformed one or more categorical variables. Additionally, training the machine learning model may include optimizing the arbitrary function based on the weight for each of the transformed one or more numerical variables and the transformed one or more categorical variables.

The trained machine learning model(s) may be used to generate an optimized function associated with each selected event type and associated attributes. The system may receive a set of testing events for a selected event type. The system may apply the trained machine learning model(s) to the set of testing events in order to select one or more of the optimized functions. The optimization functions may be selected using the trained machine learning model(s) such that a highest value of a maximization function is achieved. The maximization function may be related to a group of operating parameters and/or efficiencies required by the issuer institution. The system may provide the selected optimized functions to a rule execution engine. The rule execution engine may receive a new event associated with a selected event type(s). The rule execution engine may use the selected optimized functions to determine an action to be taken based on the event. The action may be indicative of whether the event should be processed, rejected, or a security action should be taken (e.g., the event may be flagged for further review).

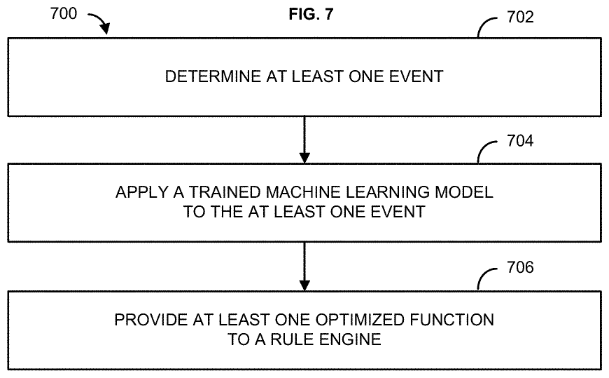

Turning now to FIG. 7, an example method 700 for improved fraud detection and reduction is shown. The method 700 may be performed by the rule engine 116 of FIG. 1. One or more steps of the method 600 may incorporate one or more steps of the processes 300 and/or 400 to train a machine learning model.

For example, a system associated with an issuer institution may receive a number of analysis parameters for detecting and reducing fraud. Using the analysis parameters, the system may determine a set of training events for each of a number of selected event types for analysis. Each event type may include one or more attributes, such as numerical variables, categorical variables, an action(s), etc. The system may transform each of the attributes for each event type. The attributes may be transformed using one or more of an injective transformation, a binary operation, variable elimination, a combination thereof, and/or the like. The one or more categorical variables for each of the training events may be mapped to an arbitrary metric using one or more of a Bayesian inference model or eigenvector transformation. The system may determine a predicted action for each event based on, for example, the transformed attributes for each event.

Determining the predicted action may include generating an arbitrary function for each of the training events based on the transformed one or more numerical variables and the mapped one or more categorical variables. Based on the arbitrary function, a predicted action may be assigned for an event. The system may include a machine learning module. The predicted action for each event may be provided to the machine learning module to train a machine learning model(s) for fraud detection and prevention. Training the machine learning model may include determining a difference between the determined action and the predicted action for an event. Further, training the machine learning model may include determining, based on the difference between the determined action and the predicted action for the event, a weight for each of the transformed one or more numerical variables and the transformed one or more categorical variables. Additionally, training the machine learning model may include optimizing the arbitrary function based on the weight for each of the transformed one or more numerical variables and the transformed one or more categorical variables.

The machine learning module may receive a testing dataset based on user inputs and system inputs and/or a model selected. At step 702, machine learning module may determine at least one event from among the testing dataset. The testing dataset may include a plurality of events. Each event may include one or more numerical variables, one or more categorical variables, and an action. At step 704, the machine learning module may apply a trained machine learning model to the at least one event of the testing dataset to select one or more of the optimized functions that result in a highest value of at least one maximization function.

The machine learning module may apply the trained machine learning model to the testing dataset using an arbitrary ring structure consisting of the optimized functions as members and outputs. The machine learning module may apply one or more binary operations to the ring structure. The machine learning module may select one or more of the optimized functions that result in a highest value of the at least one maximization function. The at least one maximization function may include a numerical value. For example, the numerical value may be based on one or more optimization metrics. The at least one maximization function may be an arbitrary scalar profit function. The arbitrary scalar profit functions may defined as having (1) a global profit component that may calculate a numerical value for a particular sequencing of rule executions against the model selected (e.g., a total cost of fraudulent activity); and (2) and individual profit component that may calculate a numerical value for each individual rule based on the optimization metrics.

For each permutation of rule ordering employed by the ring structure, the machine learning module may calculate a global profit and select the permutation resulting in the greatest profit. Rules with greater individual profit will then be prioritized for ring combination. In this case, an arbitrary number of the binary operations defined by the ring structure may be applied to the functions to generate a new set of functions. The number of binary operations that a rule may be engaged in may be dictated by the individual profit component in order to promulgate better rules, with the worst performing rules dropped from the system altogether. The selected one or more of the optimized functions may be selected based on a maximization of the numerical value.

At step 704, the selected one or more of the optimized functions may be provided by the machine learning module to a rules execution module for deployment. The rules execution module may receive a new event comprising an event type, one or more numerical variables, and one or more categorical variables. The rules execution module may use the selected one or more of the optimized functions to determine an action based on the event. The action may be indicative of whether the event should be processed or rejected.

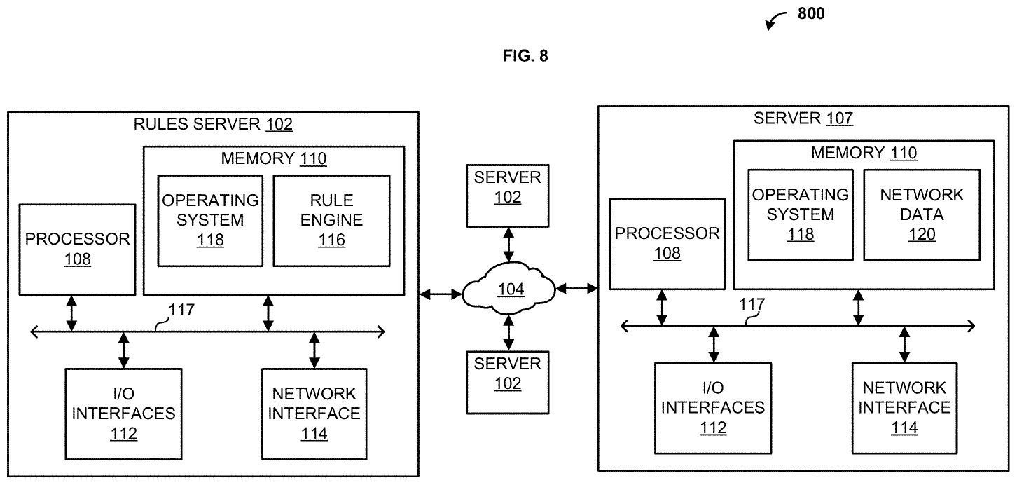

Turning now to FIG. 8, a block diagram of an example system 800 for improved fraud detection and reduction is shown. The system 800 may include one or more of the devices/entities shown in FIG. 1 with respect to the system 100. For example, the system 800 may include the rules server 102 and a server, such as the servers 107A, 107B, 107C as well as a database, such as the database 106A, 106B, or 106C, in communication via the network 104. The rules server 102 may include one or more computers each configured to store one or more of the rule engine 116, an operating system 118, and/or the like. The servers 107A, 107B, 107C may include a memory 100 storing network data 120 (e.g., historical event data). Multiple gateways 106 may be in communication with the server(s) 102 through the network 104 such as, for example, the Internet.

The rules server 102 and the servers 107A, 107B, 107C may each be a computer that, in terms of hardware architecture, may each include a processor 108, a memory 110, an input/output (I/O) interface 114, and/or a network interface 114. These may be communicatively coupled via a local interface 117. The local interface 117 may be one or more buses or other wired or wireless connections, as is known in the art. The local interface 117 may have additional elements, which are omitted for simplicity, such as controllers, buffers (caches), drivers, repeaters, and/or receivers, to enable communications. Further, the local interface 117 may include address, control, and/or data connections to enable appropriate communications among the aforementioned components.

Each processor 108 may be a hardware device for executing software, such as software stored in the corresponding memory 110. Each processor 108 may be any custom-made or commercially available processor, a central processing unit (CPU), an auxiliary processor among several processors associated with the rules server 102 and the servers 107A, 107B, 107C, a semiconductor-based microprocessor (in the form of a microchip or chip set), and/or generally any device for executing software instructions. When the rules server 102 and/or the servers 107A, 107B, 107C are in operation, each processor 108 may be configured to execute software stored within the corresponding memory 110, to communicate data to and from the corresponding memory 110, and to generally control operations of the rules server 102 and/or the gateway 106 pursuant to the software.

The I/O interfaces 112 may be used to receive user input from and/or for providing system output to one or more devices or components. User input may be provided via, for example, a keyboard and/or a mouse. System output may be provided via a display device and a printer (not shown). The I/O interfaces 112 may include, for example, a serial port, a parallel port, a Small Computer System Interface (SCSI), an IR interface, an RF interface, a universal serial bus (USB) interface, and/or the like.

The network interfaces 114 may be used to transmit and receive from an external device, such as the rules server 102 or the servers 107A, 107B, 107C on the network 104. The network interfaces 114 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interfaces 114 may include address, control, and/or data connections to enable appropriate communications on the network 104.

The memory 110 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 110 may incorporate electronic, magnetic, optical, and/or other types of storage media. Note that the memory system 110 may have a distributed architecture, where various components are situated remote from one another, but may be accessed by the processor 108.

The software stored the in memory 110 may include one or more software programs, each of which may include an ordered listing of executable instructions for implementing logical functions. For example, as shown in FIG. 8, the software in the memory 110 of the rules server 102 may include the rule engine 116 and the operating system (O/S) 118. As also shown in FIG. 8, the software in the memory 110 of the gateway 106 may include the network data 120 and the operating system (O/S) 118. Each operating system 118 may control execution of other computer programs, such as the rule engine 116 of the rules server 102. Each operating system 118 may provide scheduling, input-output control, file and data management, memory management, and/or communication control and related services.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, based on at least one analysis parameter, at least one event comprising an event type;
determining, for the at least one event, a predicted action; and
training, based on the predicted action for the at least one event, a machine learning model.

2. The method of claim 1, wherein the at least one event comprises one or more numerical variables and one or more categorical variables.

3. The method of claim 2, further comprising:
transforming the one or more numerical variables and the one or more categorical variables.

4. The method of claim 3, wherein determining, for the at least one event, the predicted action is based on the transformed one or more numerical variables and the transformed one or more categorical variables.

5. The method of claim 2, wherein determining the predicted action comprises:
mapping the one or more categorical variables to an arbitrary metric using one or more of a Bayesian inference model or eigenvector transformation;
generating an arbitrary function based on the transformed one or more numerical variables and the mapped one or more categorical variables; and
assigning, based on the arbitrary function, the predicted action.

6. The method of claim 5, wherein training the machine learning model comprises:
determining a difference between an actual action for the at least one event and the predicted action for the at least one event;
determining, based on the difference, a weight for each of the one or more numerical variables and the one or more categorical variables; and
optimizing the arbitrary function based on the weight for each of the one or more numerical variables and the one or more categorical variables.

7. The method of claim 6, wherein the trained machine learning model comprises the optimized functions.

8. A method comprising:
determining, based on at least one analysis parameter, a plurality of events for each of a plurality of event types, wherein each event comprises an action; and
applying a trained machine learning model to the plurality of events to select one or more of a plurality of optimized functions that result in a highest value of at least one maximization function.

9. The method of claim 8, wherein the at least one analysis parameter comprises an event type, a probability score, or an optimization metric.

10. The method of claim 8, wherein the trained machine learning model comprises the plurality of optimized functions, and wherein the plurality of optimized functions are associated with a plurality of training events.

11. The method of claim 8, further comprising:
providing the selected one or more of the plurality of optimized functions to a rule execution engine;
receiving, by the rule execution engine, an event comprising an event type; and
determining an action based on the event and the selected one or more of the plurality of optimized functions.

12. The method of claim 11, wherein the action is indicative of whether the event should be processed, rejected, monitored, or trigger a security action.

13. The method of claim 8, wherein applying the trained machine learning model to the plurality events to select one or more of the plurality of optimized functions that result in a highest value of the at least one maximization function comprises:
generating a ring structure comprising the plurality of optimized functions;
applying one or more binary operations to the ring structure; and
selecting one or more of the plurality of optimized functions that result in a highest value of the at least one maximization function.

14. The method of claim 8, wherein the at least one maximization function comprises a numerical value based on one or more optimization metrics, and wherein one or more of the plurality of optimized functions are selected based on a maximization of the numerical value.

15. An apparatus comprising at least one processor and memory storing processor-executable instructions that, when executed by the at least on processor, cause the apparatus to:
determine, based on at least one analysis parameter, at least one event comprising an event type;
determine, for the at least one event, a predicted action; and
train, based on the predicted action for the at least one event, a machine learning model.

16. The apparatus of claim 15, wherein the at least one event comprises one or more numerical variables and one or more categorical variables.

17. The apparatus of claim 16, wherein the processor-executable instructions further cause the apparatus to:
transform the one or more numerical variables and the one or more categorical variables.

18. The apparatus of claim 15, wherein the processor-executable instructions that cause the apparatus to determine the predicted action further cause the apparatus to:
map the one or more categorical variables to an arbitrary metric using one or more of a Bayesian inference model or eigenvector transformation;
generate an arbitrary function based on the transformed one or more numerical variables and the mapped one or more categorical variables; and
assign, based on the arbitrary function, the predicted action.

19. The apparatus of claim 18, wherein the processor-executable instructions that cause the apparatus to train the machine learning model further cause the apparatus to:
determine a difference between an actual action for the at least one event and the predicted action for the at least one event;
determine, based on the difference, a weight for each of the one or more numerical variables and the one or more categorical variables; and
optimize the arbitrary function based on the weight for each of the one or more numerical variables and the one or more categorical variables.

20. The apparatus of claim 19, wherein the trained machine learning model comprises the optimized functions.
